(19) United States
(12) Patent Application Publication
(10) Pub. No.: US 2025/0371885 A1
(43) Pub. Date: Dec. 4, 2025

(54) METHOD AND INSTALLATION FOR COUNTING OBJECTS IN A MOVING VEHICLE

(71) Applicant: L'Air Liquide, Societe Anonyme pour l'Etude et l’Exploitation des Procedes Georges Claude, Paris (FR)

(72) Inventors: Hubert LAM, Jouy-En-Josas (FR); Habiboulaye AMADOU-BOUBACAR, Jouy-En-Josas (FR); Michele QUATTRONE, Jouy-En-Josas (FR); Thierry RENAULT-CTAS, Jouy-En-Josas (FR)

(21) Appl. No.: 18/998,375

(22) PCT Filed: Jul. 17, 2023
(86) PCT No.: PCT/EP2023/069778

§ 371 Date: Jan. 24, 2025

(30) Foreign Application Priority Data
Jul. 28, 2022 (FR) FR2207759

(51) Int. Cl. G06V 20/54; G06V 10/10; G06V 10/764; G06V 10/82; G07C 9/30

(52) U.S. Cl. CPC G06V 20/54; G06V 10/764; G07C 9/30; G06V 10/16; G06V 10/82; G06V 2201/08

(57) ABSTRACT

Disclosed are a method and an installation for discontinuously counting objects on a moving vehicle, the vehicle moving in a continuous flow along a straight or substantially straight course, for example for counting gas cylinders loaded on a moving vehicle, for example a vehicle entering and/or leaving an industrial site.

### CROSS-REFERENCE TO RELATED APPLICATIONS

This application is a § 371 of International PCT Application PCT/EP2023/069778, filed Jul. 17, 2023, which claims § 119(a) foreign priority to French patent application FR 2207759, filed Jul. 28, 2022.

### BACKGROUND

### Field of the Invention

The present invention relates to the field of counting and differentiating between objects or physical people, or even animals, passing by, via analysis of video images.

In this technical field the prior art is large in amount and very varied, both in respect of the “objects” counted and of the circumstances under which the counting occurs and therefore the methods employed.

### Related Art

Mention will be made here, by way of illustration, of the following documents: EP-3 005 231A2, WO09/004479, WO22/076443A1, U.S. Pat. Nos. 10,559,091, 10,769,808 and WO17/123920A1, or indeed CN113763433A.

In the context of the present invention, what is especially of interest is discontinuous counting of physical objects flowing continuously one-way, i.e. moving in a substantially straight line, this continuous flow of physical objects here, i.e. in the present case, being obtained in an industrial environment such as a factory, a gas-cylinder filling centre, or even a gas-cylinder distribution centre, where flows of entering and exiting vehicles transporting gas cylinders are observed, a flow possibly entering or exiting via the same site access or indeed via different site accesses, the invention allowing the objects in question to be counted but also, where appropriate, the number of counted objects to be classified into determined sub-categories, for example cylinder colours (and therefore types of gas) or even for example cylinders of different types of caps, or even cylinders of different diameters, etc.

### SUMMARY OF THE INVENTION

Therefore, as will be seen in more detail below, the present invention aims to provide a method and installation for counting cylinders entering, or exiting, the site, irrespectively of whether the cylinders are full or empty, of different sizes and colours or equipped with cylinder caps of very varied forms, the method being automated, and improving the reliability of existing techniques.

As was seen above, the present invention relates to discontinuous counting of physical objects flowing continuously in one direction, so the vocabulary used in this technical field will now be explained:
The flow is said to be continuous when the objects of interest present therein do not stop during the phase of acquisition of a camera. In the context of the present invention, this is the case addressed: the truck does not stop under the camera, which thus gets only a partial view of the load of the truck in each of the constituent images of the video. Even were the camera to be able to see the entirety of the load of the vehicle and/or were the vehicle to stop, intentionally or unintentionally, and/or were the path followed by the vehicle to be able to be of any nature, the present invention would still remain, as will be seen, robust and applicable under these conditions of image capture.
A flow is said to be discontinuous when the objects stop for each acquisition and then move on.
Counting is said to be discontinuous when objects of interest are counted in groups and not counted cumulatively over a given period. In the context of the present invention, what is of interest is counting cylinders per vehicle.
Counting is said to be continuous when the objects of interest counted are not “grouped”, this for example being the case of customers entering or exiting a commercial building.

It is known in the literature to discontinuously count a discontinuous flow, the field of a sensor then including the entirety of the count region, which remains still for a short time so as to allow a complete image to be acquired via a dedicated camera and said image to be analysed via a suitable algorithm.

It is also known to continuously count in a continuous flow, it then being sought to estimate the variation in an indicator, the notion of units or groups of objects being inapplicable. Mention may here be made of the example given above of counting customers entering into a commercial property.

It has therefore become necessary to provide a new counting method addressing the problem confronted here, where it is not the vehicle that is the object of interest but the objects, cylinders for example, that it is transporting, and therefore where it is sought to count the number of cylinders PER TRUCK, under conditions where the truck does not stop to allow an image to be captured—it passes without stopping (“continuous flow”) under a gantry equipped with image-capturing means—and where the field of a camera positioned on the gantry is necessarily not large enough to encompass the entirety of the load of the truck (counting is therefore discontinuous because it is necessary to analyse the video and to isolate the sequence of interest corresponding to the passage of the truck).

It will be noted that, if another comparative approach (not that of the present invention) in which counting was continuous were used, the number of cylinders would be counted and summed as a plurality of vehicles passed during a given period of time.

As will be clearly apparent to anyone skilled in the art, the approach chosen by the present invention and the nature of the technical problem thus induced is such that:
the vehicles of interest are visually differentiable from other elements or vehicles that may pass through the region in question (such as cars, tanker trucks, bicycles, pedestrians, fork-lift trucks, etc.). However, in the present case, although two vehicles of interest are of the same nature, a vehicle A transporting cylinders must be able to be differentiated from another vehicle B also transporting cylinders (for example because certain logistical flows must be excluded from the count for a given reason X or Y). This differentiation cannot be achieved naturally, either based on the appearance of these vehicles, or on the content of their load. It is however necessary to compare the number of counted objects to a “valid” number contained in the information systems;
the length of the vehicle transporting the gas cylinders is generally large enough for the field of the camera to be unable to encompass the entirety of the load, acquisition of a single image being insufficient to count all the cylinders and a video stream thus being required;
with regard to the preceding point, although the camera could certainly be installed at greater height, this would then potentially be incompatible with the legislation in force in certain countries (installation standards, safety, etc.);
a manual count would be neither systematic nor reliable. Such a method cannot therefore be based on trust accorded to a human, factors that might decrease reliability especially being non-respect of guidelines, the weather, light levels, etc.;
the counting method must allow for overlap of the objects of interest due to the time component of the video stream.

### DETAILED DESCRIPTION OF THE INVENTION

The aim of the present invention is to allow the following objectives to be achieved:
routine count keeping by the technical solution with a human in the loop with a view to performing a manual count when discrepancies are significant with respect to a target value and thus to allowing a mistake to be corrected;
processing a continuous flow with a view to performing a discontinuous count, systematically and independently of human factors, this allowing the nature and configuration of existing flows to be preserved and therefore transparency with respect to users to be achieved (implementation of the method according to the invention will not require the site to be shut down, the design of factories or flows to be re-examined, the tasks of each operator to be redefined, etc.).

The present invention thus relates to a method for discontinuously counting objects present on a vehicle in movement, the movement being a continuous flow along a straight or substantially straight path, the vehicle being considered to be a vehicle of interest that is identifiable with respect to other vehicles of an identical or different nature, for example for counting gas cylinders loaded on a moving vehicle, for example one entering and/or exiting from an industrial site, wherein:
a. at least one assembly consisting of at least one camera arranged on a gantry is provided, the at least one camera having a horizontal field of view dimensioned to encompass at least the width of the vehicle and allowing a video stream of objects present on the vehicle to be collected during its passage under the gantry;
b. a processor is provided, the processor for example being embedded in the camera, or even integrated into a computing facility located in an ancillary position in the vicinity of the gantry, or even remote (cloud computing), the processor being configured to:
   i. process the videos delivered by said one or more cameras to isolate the video sequence containing the passage of the vehicle of interest and to determine the number of objects present on the vehicle and the associated uncertainty;
   ii. compare the number of objects thus determined to a target value, for example one corresponding to a number of expected objects, for example a number of expected objects such as stipulated in information systems, for example such as stipulated on a delivery note regarding delivery of objects to the site in question;
c. advantageously displaying means that interact with the processor are provided, these displaying means allowing the determined number of objects, the associated uncertainty and the target value to be published on these displaying means simultaneously;
d. if the difference between the determined number of objects and the target value is larger than a given setpoint, the processor orders execution of an action or of a plurality of actions, for example transmission and display of an anomaly alert, or even a manual recounting action of the load in question by a physical person present on the site;

said vehicles of interest, the load of which it is desired to count, being equipped with a distinctive pattern recognizable by said processor, allowing the vehicles of interest to be differentiated from other elements passing in the vicinity of the gantry (and therefore through the field of view and of analysis of the camera), whether these elements are of the same nature or of a different nature (such as cars, trucks, tanker trucks, bicycles, pedestrians, fork-lift trucks, etc.), said distinctive pattern for example consisting of one or more ArUco markers placed on each vehicle of interest, or even of any other recognizable distinctive pattern such as QR codes.

It will therefore be understood that the present invention is noteworthy in that it aims to make it possible to differentiate between what it considers to be “vehicles of interest”, i.e. vehicles the load of which it is desired to count, which vehicles of interest are therefore visually differentiable from other elements passing through this region, whether these elements are of the same nature or of a different nature.

Furthermore, in the present case, according to the present invention, although two vehicles of interest are of the same nature, a vehicle A transporting cylinders must be able to be differentiated from another vehicle B also transporting cylinders (for example because certain logistical flows must be excluded from the count for a given reason X or Y). This differentiation cannot be achieved naturally, either based on the appearance of these vehicles, or on the content of their load. It is however necessary to compare the number of counted objects to the valid number that is contained in the information systems (for example a delivery note).

In other words, it should be understood that the method of the invention allows:
selection of vehicles of interest in a video stream;
and discontinuous counting of objects present on these vehicles of interest;
bearing in mind that the vehicles have a load that is partially or completely visible at each given point in time through the video stream;
but also panoramic reconstruction of the load of the vehicles, which may be likened to reconstruction, based on video images, of a top view making it possible to visualize the load of the objects, for example cylinders and their distribution over the vehicle, for example in differentiated groups of cylinders, of different sizes and colours, or equipped with cylinder caps of different forms, etc.

The present invention also relates to an installation for discontinuously counting objects present on a vehicle in movement, the movement being a continuous flow along a straight or substantially straight path, the vehicle being considered to be a vehicle of interest that is identifiable with respect to other vehicles of an identical or different nature, for example for counting gas cylinders loaded on a moving vehicle, for example one entering and/or exiting from an industrial site, said installation comprising the following elements:
a) at least one gantry equipped with at least one camera, the at least one camera having a horizontal field of view dimensioned to encompass at least the width of the vehicle and allowing a video stream of objects present on the vehicle to be collected during its passage under the gantry;
b) a processor, the processor for example being embedded in the camera, or even integrated into a computing facility located in an ancillary position in the vicinity of the gantry, or even remote (cloud computing), the processor being configured to:
   i) process the videos delivered by said one or more cameras to isolate the video sequence containing the passage of the vehicle of interest and to determine the number of objects present on the vehicle and the associated uncertainty;
   ii) compare the number of objects determined to a target value, for example one corresponding to a number of expected objects, for example a number of expected objects such as stipulated in information systems, for example such as stipulated on a delivery note regarding delivery of objects to the site in question;
c) and advantageously comprising displaying means that interact with the processor, these means being able to publish the number of objects determined, the associated uncertainty and the target value;

said vehicles of interest, the load of which it is desired to count, being equipped with a distinctive pattern, said distinctive pattern for example consisting of one or more ArUco markers placed on each vehicle of interest, or even of any other distinctive pattern placed on each vehicle of interest such as one or more QR codes, and said processor being able to recognize said distinctive pattern and thus differentiate the vehicles of interest from other elements passing in the vicinity of the gantry, whether these elements are of the same nature or of a different nature.

The present invention will possibly implement one or more of the following embodiments:
said camera is an RGB camera compatible with outside use, and able to collect a high-resolution video stream;
said processor is a CPU/GPU;
said processor uses software composed of two modules: a first module based on artificial intelligence, of the type referred to as deep learning or deep neural networks, the second being an image-processing-based counting algorithm;
the installation is positioned at an entrance and/or at an exit of the site in question, in order to allow vehicles entering and/or exiting the site to be processed, the vehicles not being required to cross paths under the same gantry;
the installation is positioned in a single location, an entrance or exit of the site in question, and allows vehicles entering and exiting via this single location to be processed, two vehicles not being able to cross paths simultaneously under the gantry with which this location is equipped.

However, it is possible, without in any way departing from the scope of the present invention, to use other means to perform such functions, such as:
an infrared camera, especially for night-time acquisitions: the video will then be greyscale and not colour, this mode therefore preventing information from being acquired on the colour of the cylinders, which colour provides useful information on the nature of the gas. Lights may be added for night-time acquisitions or acquisitions when it is dark.
a processor configured with “tracking” software: allowing a unique tracking number or “identifier” to be attributed to each object in the video (so as not to count the same object twice) and, in the end, the number of identifiers to be counted so as to obtain the number of objects, cylinders for example, this method often being used when it is a question of a video stream.

The notion of substantially straight direction or “one-way” will be clarified below. According to the invention, situations in which the vehicles follow a straight or substantially straight route are preferred, this for example being achieved through use of a narrow road upstream of the gantry, or for example through installation of boundaries such as studs, continuous guiding line markings, etc.

Use of such configurations allows such a preferred straight path to be obtained.

In this context, if a given reference axis is considered (for example a north-south axis), said route may make any angle to this reference axis, provided that the “deviated” axis adopted remains substantially straight.

The camera may then for example be positioned such that the apparent path of the truck in the video is vertical, but this is merely one non-limiting example. If the path of the truck appears oblique in the video, then it is recommended, according to the invention, to rotate the camera so as to obtain the desired result.

In summary, the route followed upstream of the gantry will induce a straight or almost straight path, while the way in which the camera is positioned will allow the angle of this path to be set so as to facilitate the counting method.

The case of delivery notes for gas-cylinder delivery to an industrial site, for example a cylinder-filling site, will be considered below.

Conventionally, the following situations are encountered, but they are merely illustrative of the very varied situations that may arise:
during a round of delivery (and of collection) of gas cylinders, to manufacturers, laboratories, universities, etc., any discrepancies observed on the round are generally reported manually by the driver on the delivery note (cylinders lost, already collected on previous rounds, etc.). It is therefore possible to consider here that, according to the invention, the processor computes the number of cylinders, based on the videos, and the associated uncertainty, makes a comparison with the indications present on the note, and displays the result. Since the driver knows the expected number of cylinders (from the delivery note) she or he is able to examine this display and potentially initiate a manual recount.
in another envisageable situation, any discrepancies on the round are reported by the driver on a mobile application that is synchronized with resource and cylinder-delivery schedules. On return to the factory, the processor computes the number of cylinders, based on the videos, and the associated uncertainty, and it retrieves the expected number of cylinders from said schedules and verifies whether this value indeed falls within the predicted interval, then displays the result. The processor is then in a position to trigger/optionally display an alert, for example with a view to initiation of a manual recount.

One example of a procedure for processing images received by the processor will now be described.
a) Starting with the continuous (video) stream, sequences of interest corresponding to the passage of the vehicle are isolated: for example using a binary classifier, such as a neural network, i.e. a mathematical model trained to identify the presence or absence of a vehicle of interest in the image, which model is for example associated with a detector of ArUco markers, which markers are placed on each vehicle of interest in order to be able to identify such vehicles of interest and to distinguish them from other vehicles that will thus be considered irrelevant.
b) Objects of interest are detected on the vehicle using an artificial neural network, i.e. a mathematical model trained to identify objects of interest in each image.
c) The rate of movement in pixels of the vehicle is estimated by exploiting the coordinates of detections (resulting from inference) in the successive images.
d) Processing is carried out with the aim of binarizing the images by setting to 1 (or to other values allowing categories of objects to be differentiated) pixels in regions:
   i) such as defined by the coordinates of detections the score of which is higher than a given threshold,
   ii) converted into circles of diameter smaller, than a given factor, than the minimum between the width and height of the detections, and by setting to 0 all the rest.
e) Taking into account the result of c), the movement in pixels of the vehicle is estimated. Since the movement may be assumed to be straight between two images, a rotation of the image allows a straight vertical movement to be simulated.
f) N rows are defined:
   i) perpendicular to the movement of the vehicle
   ii) placed at various horizontal positions in the image
   iii) the thickness of which is equal to the movement in pixels of the vehicle computed in section e). The strips extracted for each respective image are assembled vertically in order to reconstruct a “count panorama”. This same processing is also applied to the background images in order to reconstruct a “panorama of the vehicle”.
   C iterations of morphological closure are applied to the N count panoramas obtained in f) iii).
g) The number of elements in each of the N mosaics are counted, those of inconsistent size optionally being filtered out, and the final count and uncertainty are deduced therefrom by computing the weighted mean (the central rows have more weight than those at the ends) and standard deviation, respectively.

### BRIEF DESCRIPTION OF THE FIGURES

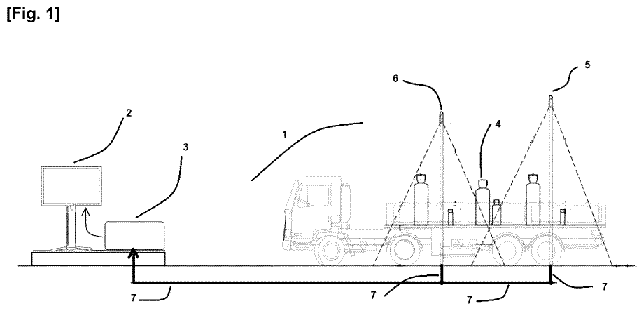

The appended FIGURE, FIG. 1, illustrates one example of an installation suitable for implementation of the invention, which example here employs a processor integrated into a computing facility located in an ancillary position located in the vicinity of the gantry.

The nomenclature of the elements present in FIG. 1 is as follows:
1: the truck transporting the cylinders (4) to be counted (which has been shown in the background and drawn with faint lines)
2: a displaying means
3: a computer
5: an entry camera
6: an exit camera
7: (the flow of information from the cameras to the computer, in thick lines)

An installation comprising two cameras on this gantry has therefore been shown in the example; however, as mentioned above, a single camera would be sufficient in the context of the present invention.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-9. (canceled)

10. A method for discontinuously counting objects present on a vehicle in movement, the movement being a continuous flow along a straight or substantially straight path, the vehicle being a vehicle of interest that is identifiable with respect to other vehicles of an identical or different nature, the method comprising:
a. providing at least one assembly comprising at least one camera arranged on a gantry, wherein the at least one camera has a horizontal field of view dimensioned to encompass at least the width of the vehicle and is configured to produce a video stream of objects present on the vehicle to be collected during passage under the gantry;
b. providing a processor, wherein the processor is embedded in the camera, or integrated into a computing facility located in an ancillary position in the vicinity of the gantry, or remote, and wherein the following measures are implemented using the processor:
i. processing the videos delivered by said one or more cameras to isolate the video sequence containing the passage of a vehicle of interest and to determine the number of objects present on the vehicle and the associated uncertainty;
ii. comparing the number of objects thus determined to a target value;
c. providing displaying means that interact with the processor, wherein the displaying means publishing the determined number of objects, the associated uncertainty and the target value simultaneously;
d. wherein, if the difference between the determined number of objects and the target value is larger than a given setpoint, the processor orders execution of an action or of a plurality of actions;
said vehicles of interest, the load of which it is desired to counted, being equipped with a distinctive pattern recognizable by said processor, and said processing allowing vehicles of interest to be configured to be differentiated from other elements passing in the vicinity of the gantry, whether these elements are of the same nature or of a different nature, the processor being equipped with a mathematical model trained to detect and identify the presence of such patterns and therefore to detect and identify the presence of a vehicle of interest in said video sequence, and thus to distinguish it from other vehicles that will thus be considered irrelevant.

11. The method according to claim 10, wherein said number of objects determined as being present in each vehicle are differentiated between with a view to classifying the number of counted objects into determined object sub-categories.

12. The method according to claim 10, wherein said at least one assembly is positioned at an entrance and/or at an exit of the site in question, thereby allowing vehicles entering and/or exiting the site to be processed, the vehicles not being required to cross paths under the same gantry.

13. The method according to claim 10, wherein said at least one assembly is positioned in a single location, at an entrance or at an exit of the site in question, thereby allowing vehicles entering and exiting via this single location to be processed, two vehicles not being capable of crossing paths simultaneously under the gantry with which this location is equipped.

14. The method according to claim 10, wherein said at least one camera is an RGB camera compatible with outside use, and configured to collect a high-resolution video stream.

15. The method according to claim 10, wherein said processor is a CPU/GPU processor.

16. The method according to claim 15, wherein said processor uses software composed of two modules: a first module based on artificial intelligence, of the type referred to as deep learning or deep neural networks, the second being an image-processing-based counting algorithm.

17. The method according to claim 10, wherein panoramic reconstruction of the load of the vehicles of interest is carried out during said processing.

18. An installation for discontinuously counting objects present on a vehicle in movement, the movement being a continuous flow along a straight or substantially straight path, the vehicle being a vehicle of interest that is identifiable with respect to other vehicles of an identical or a different nature, said installation comprising the following elements:
a) at least one gantry equipped with at least one camera, the at least one camera having a horizontal field of view dimensioned to encompass at least the width of the vehicle and allowing a video stream of the objects present on the vehicle to be collected during passage under the gantry;
b) a processor, the processor for example being embedded in the camera, or even integrated into a computing facility located in an ancillary position in the vicinity of the gantry, or even remote (cloud computing), the processor being configured to:
i) process the videos delivered by said one or more cameras to isolate the video sequence containing the passage of the vehicle of interest and to determine the number of objects present on the vehicle and the associated uncertainty;
ii) compare the number of objects determined to a target value, for example one corresponding to a number of expected objects;
c) and comprising displaying means that interact with the processor, these means being configured to publish the number of objects determined, the associated uncertainty and the target value;
said vehicles of interest, the load of which it is desired to count, being equipped with a distinctive pattern, said distinctive pattern for example consisting of one or more ArUco markers placed on each vehicle of interest, or even of any other distinctive pattern placed on each vehicle of interest such as one or more QR codes, and said processor being configured to recognize said distinctive pattern and thus differentiate the vehicles of interest from other elements passing in the vicinity of the gantry, whether these elements are of the same nature or of a different nature.
